(19) United States
(12) Patent Application Publication
(10) Pub. No.: US 2018/0231975 A1
(43) Pub. Date: Aug. 16, 2018

(54) VEHICLE ENTERTAINMENT SYSTEM

(71) Applicant: GM Global Technology Operations LLC, Detroit, MI (US)

(72) Inventors: Anil K. Sachdev, Rochester Hills, MI (US); Thomas A. Seder, Fraser, MI (US); Omer Tsimhoni, Bloomfield Hills, MI (US)

(21) Appl. No.: 15/434,596

(22) Filed: Feb. 16, 2017

(51) Int. Cl. G05D 1/00; G01C 21/36; B60Q 9/00

(52) U.S. Cl. CPC G05D 1/0061; B60Q 9/00; G01C 21/3697

(57) ABSTRACT

A vehicle includes an autonomous driving system and a vehicle entertainment system. The autonomous driving system has an environmental monitoring system that is configured to monitor an object within an external operating environment. The autonomous driving system is configured to control the vehicle in an autonomous mode. The vehicle entertainment system is configured to output for display, user-selected media via a display system and is configured to output for display, a first indicator indicative of the object within the external operating environment, while the vehicle is operating in the autonomous mode.

The subject disclosure relates to in-vehicle entertainment systems and situational awareness.

Vehicles are provided with entertainment systems that enable an operator and/or passengers of the vehicle to enjoy or experience various forms of media. The entertainment systems may also enable the presentation of information to the operator of the vehicle. The information may include details about the media displayed, traffic conditions, weather conditions, or the like. Autonomous vehicles include safety systems that monitor the operating parameters in an operating environment of the autonomous vehicle.

Accordingly, it is desirable to provide a system that displays vehicle safety information as well as the media.

### SUMMARY

In one exemplary embodiment of the present disclosure, a vehicle for operation in an autonomous or semi-autonomous mode is provided. The vehicle includes an autonomous driving system and a vehicle entertainment system. The autonomous driving system has an environmental monitoring system that is configured to monitor an object within an external operating environment. The autonomous driving system is configured to control the vehicle in an autonomous mode. The vehicle entertainment system is in communication with the autonomous driving system. The vehicle entertainment system has a display system. The vehicle entertainment system is configured to output for display, user-selected media via the display system and is configured to output for display, a first indicator indicative of the object within the external operating environment, while the vehicle is operating in the autonomous mode.

In addition to one or more of the features described herein, the vehicle entertainment system is configured to output for display, a second indicator indicative of an anticipated autonomously controlled vehicle maneuver via the display system.

In addition to one or more of the features described herein, at least one of the first indicator and the second indicator is output for display via the display system in response to the anticipated autonomously controlled vehicle maneuver.

In addition to one or more of the features described herein, in response to the environmental monitoring system detecting a condition within the external operating environment requiring driver intervention, the vehicle entertainment system is configured to output for display via the display system, a third indicator indicative of a request for driver intervention.

In addition to one or more of the features described herein, in response to the environmental monitoring system detecting a condition within the external operating environment requiring driver intervention, the vehicle entertainment system is configured to cease outputting for display the user-selected media.

In addition to one or more of the features described herein, the display system includes a projector disposed within a vehicle compartment.

In addition to one or more of the features described herein, the projector is arranged to project the user-selected media and at least one of the first indicator and the second indicator onto a vehicle windshield.

In addition to one or more of the features described herein, the projector is connected to a vehicle roof.

In addition to one or more of the features described herein, the projector is connected to a vehicle dashboard.

In another exemplary embodiment of the present disclosure, a vehicle is provided. The vehicle includes a haptic actuator, a display system, and a controller. The haptic actuator is disposed within a vehicle seat. The display system is operatively connected to a portion of a vehicle compartment. The controller is programmed to output for display via the display system, user-selected media, and operate the haptic actuator based on the user-selected media.

In addition to one or more of the features described herein, the vehicle further comprises an environmental control system is configured to vary ambient air conditions within the vehicle compartment.

In addition to one or more of the features described herein, the controller is further programmed to operate the environmental control system to vary the ambient air conditions within the vehicle compartment based on content of the user-selected media.

In addition to one or more of the features described herein, the vehicle further comprises an imaging system configured to identify an object within an external operating environment; and a ranging system configured to monitor a distance between the object within the external operating environment and the vehicle.

In addition to one or more of the features described herein, the controller is further programmed to, while an autonomous driving system operates the vehicle, output for display via the display system an indicator indicative of the object being within a predetermined distance of the vehicle.

In yet another exemplary embodiment of the present disclosure, a method is provided. The method includes presenting user-selected media via a display system while a vehicle is operating in an autonomous mode. The method further includes detecting an object within a predetermined distance from the vehicle; and in response to an anticipated autonomously controlled vehicle maneuver, outputting for display via the display system a first indicator indicative of the object relative to the vehicle.

In addition to one or more of the features described herein, the method further includes classifying the object within a predetermined category.

In addition to one or more of the features described herein, the first indicator includes an identifier indicative of the predetermined category of the object.

In addition to one or more of the features described herein, in response to detecting a condition requiring driver intervention, outputting for display via the display system, a third indicator indicative of a request for driver intervention.

In addition to one or more of the features described herein, the method further includes operating a vehicle environmental control system to vary ambient air conditions within a vehicle compartment based on content of the user-selected media.

In addition to one or more of the features described herein, the method further includes operating a vehicle environmental control system to vary ambient air conditions within a vehicle compartment based on content of the user-selected media.

The above features and advantages and other features and advantages of the present disclosure are readily apparent from the following detailed description of the present disclosure when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic view of a vehicle operating within an external environment and illustrative objects within the external environment;

FIG. 2 is a partial view of a display system while the vehicle is operating in an autonomous mode;

FIG. 3 is a partial view of the display system while the vehicle is operating in an autonomous or semi-autonomous mode;

FIG. 4. is a partial view of the display system while the vehicle is transitioning out of autonomous mode; and

FIG. 5 is a flow chart of an algorithm for operating a vehicle entertainment system.

### DESCRIPTION OF THE EMBODIMENTS

The following description is merely illustrative in nature and is not intended to limit the present disclosure, its application or uses. It should be understood that throughout the drawings, corresponding reference numerals indicate like or corresponding parts and features.

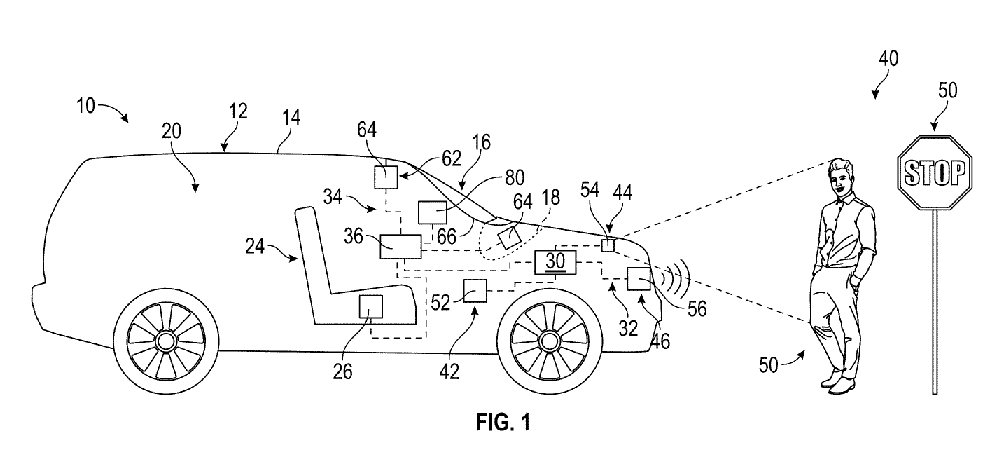

In accordance with an illustrative embodiment of the present disclosure, FIG. 1 illustrates a vehicle 10. The vehicle 10 includes a vehicle body 12, a vehicle roof 14, and a vehicle windshield 16. The vehicle windshield 16 extends from the vehicle roof 14 towards a vehicle dashboard 18. The vehicle roof 14, the vehicle windshield 16, and the vehicle dashboard 18 at least partially define a vehicle compartment 20. The vehicle dashboard 18 extends towards a center of the vehicle compartment 20 and in at least one embodiment the vehicle dashboard 18 extends towards a center console.

The vehicle 10 further includes a vehicle seat 24 that is disposed within the vehicle compartment 20. The vehicle seat 24 includes a haptic actuator 26. The haptic actuator 26 is disposed within the vehicle seat 24 and is arranged to provide a vibratory, auditory, mechanical or other indicator to an operator of the vehicle in response to various situations.

The vehicle 10 includes an autonomous driving system (ADS) 30, an environmental monitoring system 32, and a vehicle entertainment system 34. The ADS 30 is configured to control the vehicle 10 such that the vehicle 10 is an autonomous vehicle, an autonomously driven vehicle, a selectively autonomous vehicle, or a semi-autonomous vehicle. The vehicle 10 may be operated or controlled in an autonomous mode while the ADS 30 is activated and may be operated or controlled in a non-autonomous mode in which the operator of the vehicle 10 directly intervenes and takes control of vehicle 10 while the ADS 30 is not activated. A driver of the vehicle may be able to selectively activate or deactivate the ADS 30 via a switch or other mechanism.

A control module, a monitoring system, or a controller 36, is able to selectively activate or deactivate the ADS 30 in response to events occurring within or external to the vehicle 10. The controller 36 may be provided as part of the ADS 30, the environmental monitoring system 32, and the vehicle entertainment system 34. In at least one embodiment, the controller 36 may be separate from the ADS 30, the environmental monitoring system 32, and the vehicle entertainment system 34.

The controller 36 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example.

KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 36 in controlling or working in concert with the ADS 30, the environmental monitoring system 32, and the vehicle entertainment system 34.

The ADS 30 operates the vehicle 10 such that the vehicle 10 is able to perform operations without continuous input from a driver (e.g. steering, accelerating, braking, maneuvering, turning, etc.), while operating in the autonomous mode. The ADS 30 enables the vehicle 10 to be at least partially autonomously controlled based on inputs received from the environmental monitoring system 32 and/or other vehicle systems. The other vehicle systems may be a global positioning system, a mapping system, a traffic notification or monitoring system, or the like that may enable the ADS 30 control or guide the vehicle along a route.

The environmental monitoring system 32 is in communication with the ADS 30, the vehicle entertainment system 34, and the controller 36. The environmental monitoring system 32 is configured to monitor a space within the vehicle compartment 20 and to monitor and/or identify objects within an external operating environment 40 that is external to the vehicle 10 to provide situational awareness to an operator of the vehicle 10. The environmental monitoring system 32 includes an interior monitoring system 42, an imaging system 44, and a ranging system 46.

The interior monitoring system 42 includes a first sensor 52 that detects a position of the operator of the vehicle 10. The first sensor 52 monitors whether the operator is within the vehicle seat 24 or not within the vehicle seat 24. The first sensor 52 monitors the position of the driver of the vehicle while the ADS 30 is activated. In at least one embodiment, the first sensor 52 monitors the position of other occupants of the vehicle while the ADS 30 is activated.

The first sensor 52 of the interior monitoring system 42 provides data or a signal indicative of the position of the operator of the vehicle 10 to at least one of the ADS 30, the environmental monitoring system 32, the vehicle entertainment system 34, and the controller 36. The first sensor 52 may be an optical sensor, an optical camera, a seat switch, a weight sensor disposed in the vehicle seat 24, an ultrasonic sensor, a thermal sensor, a capacitive sensor, or the like. The ADS 30 may be enabled to transition between the autonomous mode and the non-autonomous mode, in response to the first sensor 52 of the interior monitoring system 42 providing a signal indicative of the operator of the vehicle 10 within the vehicle seat 24. The ADS 30 may inhibit the transition between the autonomous mode and the non-autonomous mode, in response to the sensor of the interior monitoring system 42 providing a signal indicative of the absence of the operator of the vehicle 10 from the vehicle seat 24.

The imaging system 44 detects and/or identifies object(s) 50 within the external operating environment 40 of the vehicle 10. The imaging system 44 includes a second sensor 54 that detects, identifies, and/or determines the state of the object 50. For example, the second sensor 54 is configured to identify a person, an object, another vehicle, an animal, a traffic control device, such as a stop sign, traffic light, or the like. The second sensor 54 may be an object sensor, an optical sensor, an optical camera, a thermal sensor, a laser device, or the like or a combination of the aforementioned.

The second sensor 54 of the imaging system 44 provides data or a signal indicative of the object 50 to at least one of the ADS 30, the environmental monitoring system 32, the vehicle entertainment system 34, and the controller 36. The environmental monitoring system 32 or the controller 36 may classify the object 50 within a predetermined category and determine a state of the object 50. A state of the object 50, may for example, include whether the object 50 is in motion or stationary or whether the object 50 is a stop sign, a yield sign, a green light, a yellow light, or a red light (i.e. related to traffic control or vehicle control).

The ranging system 46 detects and/or monitors a distance between the object 50 and the vehicle 10. The ranging system 46 includes a third sensor 56 that detects and/or monitors the distance between the vehicle 10 and the object 50. The third sensor 56 may be a ranging sensor, an optical sensor, an optical camera, an ultrasonic sensor, a thermal sensor, a capacitive sensor, an inductive sensor, a sonar device, an infrared detector, a laser device, a lidar device, a radar device, or the like or a combination of the aforementioned.

The third sensor 56 of the ranging system 46 provides data or a signal indicative of a distance between the vehicle 10 and the object 50 to at least one of the ADS 30, the environmental monitoring system 32, the vehicle entertainment system 34, and the controller 36. The imaging system 44 and the ranging system 46 may work in concert to identify and classify objects 50 within a predetermined distance of the vehicle 10.

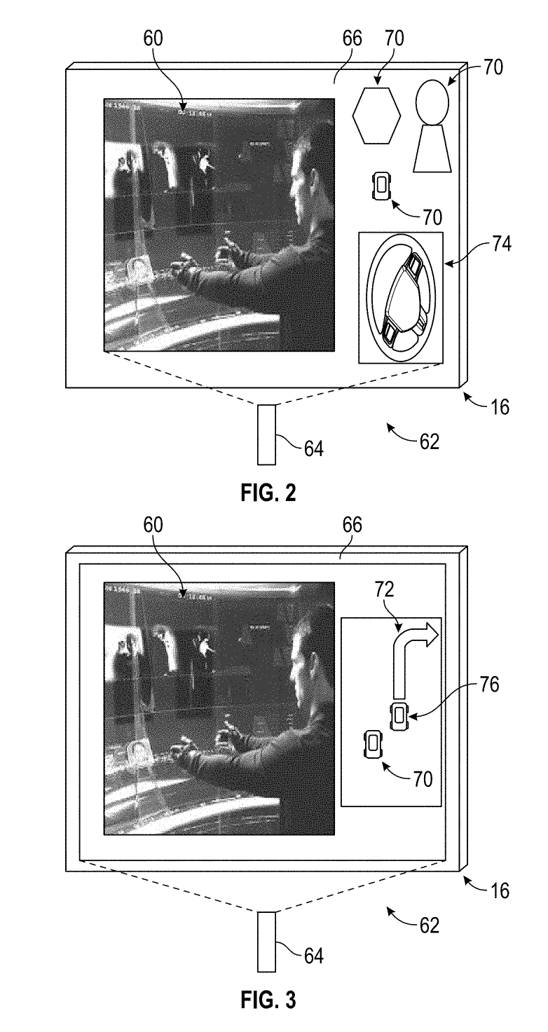

The vehicle entertainment system 34 communicates with the ADS 30, the environmental monitoring system 32, and the controller 36. The vehicle entertainment system 34 is configured to output for display user-selected media 60 via a display system 62, while the vehicle 10 is operated in an autonomous mode or the vehicle 10 is stationary, as shown in FIGS. 2 and 3. In at least one embodiment, the vehicle entertainment system 34 is configured to output for display user-selected media 60 via the display system 62 in response to a vehicle navigation or mapping system indicating traffic conditions amenable to the displaying of user-selected media 60, e.g. traffic less than a threshold amount of traffic, a number of traffic control devices less than a threshold number, lower probability of driver intervention, low to no pedestrian traffic, or the like.

User-selected media 60 may be visual entertainment such as a movie, a television show, web-based content, video clips, photographs or the like. The user-selected media 60 may include a map, the displaying of the screen or media of a nomadic device such as a computer, cellular phone or the like, or a view of the external operating environment 40 based on information provided by the environmental monitoring system 32.

The display system 62 is configured to simultaneously present and output for display the user-selected media 60 to the operator and/or occupants of the vehicle 10 as well as situational awareness information from the environmental monitoring system 32, the imaging system 44, and the ranging system 46. The display system 62 and or the vehicle entertainment system 34 may be provided with an algorithm to adjust or compensate for distortion of the projected image of the user-selected media 60 onto the projection surface 66.

The display system 62 includes a projector 64 that is arranged to project the user-selected media 60 on to a projection surface 66. The projection surface 66 may be an interior surface of the vehicle 10 such as an interior surface of the vehicle windshield 16. The projector 64 is disposed within and is operatively connected to a portion of the vehicle compartment 20. The projector 64 may be connected to the vehicle roof 14 or another component or surface within the vehicle compartment 20. In at least one embodiment, the projector 64 may be connected to the vehicle dashboard 18. In at least one embodiment, the display system 62 may include a monitor or other display screen connected to an interior surface of the vehicle 10.

Referring to FIGS. 2-4, the display system 62 is configured to output for display the user-selected media 60 and substantially simultaneously or concurrently a plurality of indicators indicative of objects 50 within the external operating environment 40 and/or impending or anticipated autonomously controlled vehicle maneuvers via the display system 62. The display system 62 of the vehicle entertainment system 34 is configured to output for display a first indicator 70, a second indicator 72, and a third indicator 74.

Referring to FIG. 2, images may be projected onto the projection surface 66 of the vehicle windshield 16 by the projector 64 of the display system 62 while the vehicle 10 is operating in an autonomous mode. The first indicator 70 is indicative of an object 50 within the external operating environment 40 and is output for display along with the user-selected media 60. The first indicator 70 may be blended both spatially and temporally with the user-selected media 60. In at least one embodiment, the first indicator 70 may be disposed adjacent to the user-selected media 60. In at least one embodiment, the first indicator 70 may be overlaid with the user-selected media 60. In at least one embodiment, multiple first indicators may be presented based on relative importance.

The first indicator 70 is output for display in response to the environmental monitoring system 32, the imaging system 44, and/or the ranging system 46 detecting and/or classifying the object 50 within a predetermined distance of the vehicle 10. The first indicator 70 may provide information to the operator of the vehicle 10 as to the classification of the object 50, e.g. a traffic control device, a pedestrian, another vehicle, or the like, and may be spatially located relative to a vehicle indicator 76 indicative of the vehicle 10. The presentation of the first indicator 70 may interrupt or pause the displaying of the user-selected media 60 or may be blended with or appended to the presentation of the user-selected media 60. In at least one embodiment, a haptic or vibratory indicator may be provided through the haptic actuator 26 of the vehicle seat 24 to the operator of the vehicle 10 based on the object 50 and/or the classification of the object 50.

Referring to FIG. 3, another view of images projected onto the projection surface 66 by the display system 62 is shown. The second indicator 72 is output for display along with the user-selected media 60 and in some situations the first indicator 70. The second indicator 72 may be blended both spatially and temporally with the user-selected media 60 and the first indicator 70. In at least one embodiment, the second indicator 72 may be disposed adjacent to the user-selected media 60 and the first indicator 70. In at least one embodiment, the second indicator 72 may be overlaid with the user-selected media 60.

The second indicator 72 is indicative of an anticipated autonomously controlled vehicle maneuver. The autonomously controlled vehicle maneuver may be anticipated based on a time or distance to the actual performance of the vehicle maneuver that may be determined by a global positioning system or the like. The second indicator 72 is output for display in response to the vehicle 10 preparing to execute a vehicle maneuvers such as a turn, a lane change, a speed change, braking, time to the next vehicle maneuver, or the like. The second indicator 72 may provide information to the operator of the vehicle 10 as to the classification of the anticipated autonomously controlled vehicle maneuver. The second indicator 72 may be presented relative to the vehicle indicator 76 that is indicative of the vehicle 10. The presentation of the second indicator 72 may interrupt or pause the displaying of the user-selected media 60 or may be blended with or appended to the presentation of the user-selected media 60. In at least one embodiment, a haptic or vibratory indicator may be provided through the haptic actuator 26 of the vehicle seat 24 to the operator of the vehicle 10 based on the anticipated autonomously controlled vehicle maneuver.

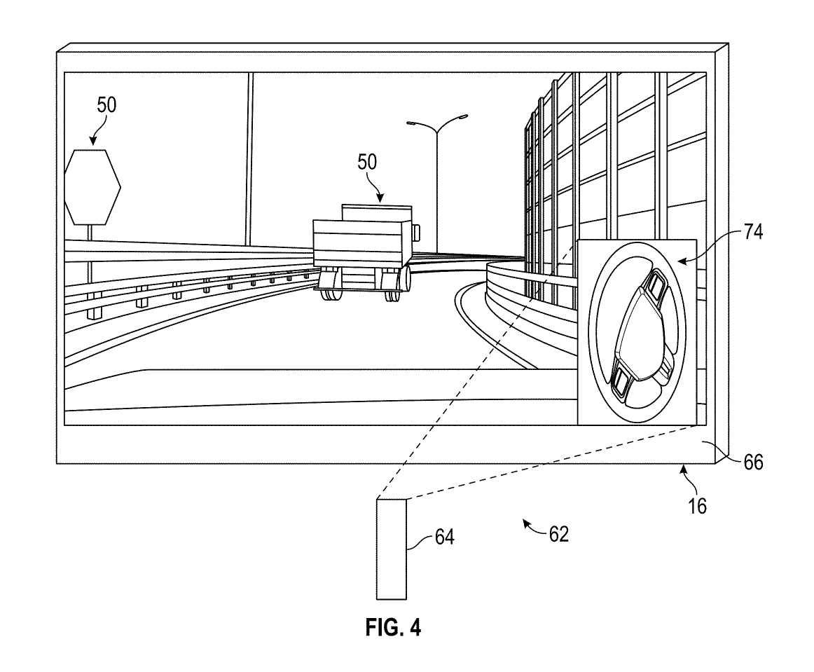

Referring to FIGS. 2 and 4, the third indicator 74 may be presented as the vehicle 10 is transitioning out of autonomous mode. The third indicator 74 may be output for display along with the user-selected media 60 and in some situations, the first indicator 70 and the second indicator 72. The third indicator 74 may be blended both spatially and temporally with the user-selected media 60 and the first indicator and the second indicator 72 or may be overlaid with the user-selected media 60.

The third indicator 74 is indicative of a request for driver intervention and is output for display in response to the environmental monitoring system 32 detecting a condition within the vehicle compartment 20 or within the external operating environment 40 that requires driver intervention. In response to the third indicator 74 being output for display, the user-selected media 60 may be paused or may cease being projected by the projector 64 onto the projection surface 66 and may deactivate the ADS 30 such that the vehicle 10 transitions between an autonomous mode and a non-autonomous mode. Situational awareness indicators such as the first indicator 70, the second indicator 72, and the third indicator 74 may continue to be displayed onto the projection surface 66 even when the user-selected media 60 is no longer projected onto the projection surface 66.

The vehicle entertainment system 34 may also be configured to operate as an in-vehicle movie theater that may provide a multisensory integrated projection system that provides additional sensory stimulation beyond auditory and visual stimulation. The vehicle entertainment system 34 may be in communication with a vehicle environmental control system 80 and the haptic actuator 26, as shown in FIG. 1. The vehicle environmental control system 80 may be a vehicle HVAC system that includes vents or apertures formed within the vehicle compartment 20, such as the vehicle dashboard 18. The vehicle environmental control system 80 is configured to vary ambient air conditions within the vehicle compartment 20 and may further vary ambient air conditions within the vehicle compartment 20 based on content of the user-selected media 60 that is projected onto the projection surface 66. For example, the vehicle entertainment system 34 may operate the environmental control system to provide additional air into the vehicle compartment 20 to simulate wind, breezes, or flight that may be occurring within the user-selected media 60. In at least one embodiment, aromas or fragrances may be preloaded and sent through the vehicle environmental control system 80 to simulate mountain fresh air, meadows, city streets, or the like.

The vehicle entertainment system 34 may operate the haptic actuator 26 within the vehicle seat 24 based on content of the user-selected media 60. The operation of the haptic actuator 26 may vibrate or otherwise actuate the vehicle seat 24 to simulate the topology of the terrain within the user-selected media 60, to simulate a car chase, flight, or the like.

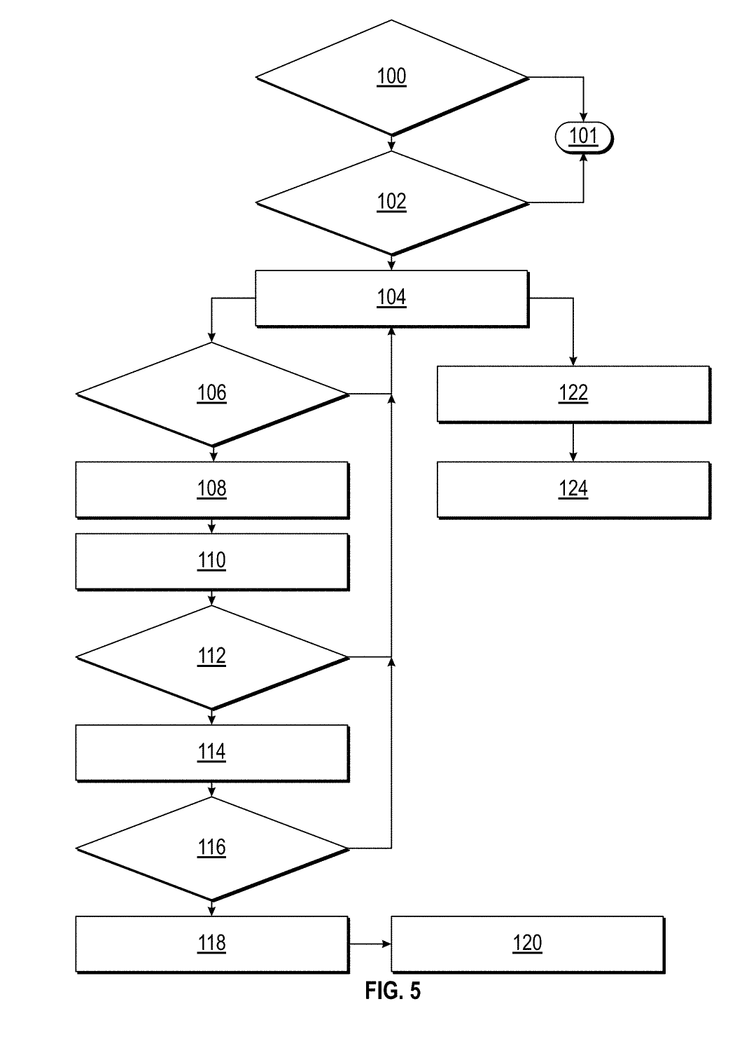

Referring to FIG. 5, a flow chart of an algorithm for operating a vehicle entertainment system 34 is shown. The method may be executed by the controller 36 and may be implemented as a closed loop control system. For brevity, the method will be described in the context of a single method iteration.

At block 100, the method determines if the vehicle 10 is operating in an autonomous mode, i.e. the ADS 30 is active and the vehicle 10 is at least partially autonomously controlled, or the vehicle 10 is at rest. If the vehicle 10 is operating in a non-autonomous mode, the method may end at block 101. If the vehicle 10 is operating in an autonomous mode or the vehicle 10 is at rest, the method continues to block 102.

At block 102, the method determines if there is a request to display the user-selected media 60 via the display system 62 onto the projection surface 66. If no request to display the user-selected media 60 is received, the method may end at block 101. If a request to display or present the user-selected media 60 is received, the method displays or presents the user-selected media 60 via the display system 62 onto the projection surface 66, at block 104. The user-selected media 60 may be displayed or presented while the vehicle is at rest or has arrived at a location such that the vehicle entertainment system 34 and the vehicle 10 may function as a personal drive-in theater.

At block 106, while the vehicle 10 is operating in the autonomous mode or the vehicle 10 is stationary, the method determines if an object 50 is within a predetermined distance of the vehicle 10. If an object 50 is not within a predetermined distance of the vehicle 10, the method continues to display or present the user-selected media 60 at block 104. If an object 50 is within a predetermined distance of the vehicle 10, as detected by the environmental monitoring system 32, the imaging system 44, and/or the ranging system 46, the method outputs for display or presentation the first indicator 70 via the display system 62 along with the user-selected media 60, at block 108.

At block 110, the method classifies the object 50 within a predetermined category. As such, the first indicator 70 provides an identifier or information that is indicative of the category of the object. The identifier or information may be a unique shape, presentation pattern, or location of the first indicator 70. For example, if the object 50 is a pedestrian, the first indicator 70 may have a generally humanoid shape. Should the object 50 be a traffic control device, the first indicator 70 may be shaped as a stop sign, yield sign, traffic light, traffic circle, etc.

At block 112, the method determines if an autonomously controlled vehicle maneuver is anticipated. If an autonomously controlled vehicle maneuver is not anticipated, the method continues to display or present the user-selected media 60. If an autonomously controlled vehicle maneuver is anticipated, the method outputs for display or presentation the second indicator 72 via the display system 62 along with the user-selected media 60, at block 114.

At block 116, the method continues to monitor the external operating environment 40 and the vehicle compartment 20 to determine whether a condition exists that may require operator intervention. Should a condition not exist that requires operator intervention, the method continues to display or present the user-selected media 60. If a condition does exist that may require operator intervention, the method outputs for display the third indicator 74, at block 118.

At block 120, the method ceases the display or presentation of the user-selected media 60, in response to the condition that may require operator intervention. The method may continue to display or present at least one of the first indicator 70, the second indicator 72, and the third indicator 74 via the display system 62 onto the projection surface 66.

Referring again to block 104, while the method displays or presents the user-selected media 60 via the display system 62 onto the projection surface 66, the method may monitor the content of the user-selected media 60. At block 122, the method may operate the vehicle environmental control system 80 to vary ambient air conditions within the vehicle compartment 20 based on the content of the user-selected media 60. At block 124, the method may operate the haptic actuator 26 disposed within the vehicle seats 24 based on the content of the user-selected media 60.

The vehicle entertainment system 34 provides architecture for displaying user-selected media 60 as well as situational awareness information based on information provided by the environmental monitoring system 32, the imaging system 44, and/or the ranging system 46 to an operator of the vehicle 10 during autonomous vehicle operation. The situational awareness information enhances safety as well as improves trust and acceptance of autonomous vehicle systems. The vehicle entertainment system 34 orchestrates the intentional switching between the displaying and presentation of entertainment and situational awareness information in a manner that is not intrusive to the entertainment while maintaining situational awareness for safety and comfort. The vehicle entertainment system 34 removes abrupt transitions that may appear when using the same display for situational awareness and entertainment purposes.

While the disclosure has been described with reference to illustrative embodiments, it will be understood by those skilled in the art that various changes may be made and equivalents may be substituted for elements thereof without departing from the scope thereof. In addition, many modifications may be made to adapt a particular situation or material to the teachings of the invention without departing from the essential scope thereof. It is intended that the applicability not be limited to the particular embodiments disclosed, but that the disclosure will include all embodiments falling within the scope thereof.

What is claimed is:

1. A vehicle for operation in an autonomous or semi-autonomous mode, comprising:
an autonomous driving system having an environmental monitoring system configured to monitor an object within an external operating environment, the autonomous driving system configured to control the vehicle in an autonomous mode; and
a vehicle entertainment system in communication with the autonomous driving system and having a display system, the vehicle entertainment system being configured to output for display, user-selected media via the display system and configured to output for display, a first indicator indicative of the object within the external operating environment, while the vehicle is operating in the autonomous mode.

2. The vehicle of claim 1, wherein the vehicle entertainment system is configured to output for display, a second indicator indicative of an anticipated autonomously controlled vehicle maneuver via the display system.

3. The vehicle of claim 2, wherein at least one of the first indicator and the second indicator is output for display via the display system in response to the anticipated autonomously controlled vehicle maneuver.

4. The vehicle of claim 3, wherein in response to the environmental monitoring system detecting a condition within the external operating environment requiring driver intervention, the vehicle entertainment system is configured to output for display via the display system, a third indicator indicative of a request for driver intervention.

5. The vehicle of claim 3, wherein in response to the environmental monitoring system detecting a condition within the external operating environment requiring driver intervention, the vehicle entertainment system is configured to cease outputting for display the user-selected media.

6. The vehicle of claim 3, wherein the display system includes a projector disposed within a vehicle compartment.

7. The vehicle of claim 6, wherein the projector is arranged to project the user-selected media and at least one of the first indicator and the second indicator onto a vehicle windshield.

8. The vehicle of claim 6, wherein the projector is connected to a vehicle roof.

9. The vehicle of claim 6, wherein the projector is connected to a vehicle dashboard.

10. A vehicle, comprising:
a haptic actuator disposed within a vehicle seat;
a display system that is operatively connected to a portion of a vehicle compartment; and
a controller programmed to:
output for display via the display system, user-selected media, and
operate the haptic actuator based on the user-selected media.

11. The vehicle of claim 10, further comprising:
an environmental control system configured to vary ambient air conditions within the vehicle compartment.

12. The vehicle of claim 11, wherein the controller is further programmed to operate the environmental control system to vary the ambient air conditions within the vehicle compartment based on content of the user-selected media.

13. The vehicle of claim 10, further comprising:
an imaging system configured to identify an object within an external operating environment; and
a ranging system configured to monitor a distance between the object within the external operating environment and the vehicle.

14. The vehicle of claim 13, wherein the controller is further programmed to, while an autonomous driving system operates the vehicle, output for display via the display system an indicator indicative of the object being within a predetermined distance of the vehicle.

15. A method, comprising;
presenting user-selected media via a display system while a vehicle is operating in an autonomous mode;
detecting an object within a predetermined distance from the vehicle; and
in response to an anticipated autonomously controlled vehicle maneuver, outputting for display via the display system a first indicator indicative of the object relative to the vehicle.

16. The method of claim 15, further comprising:
classifying the object within a predetermined category.

17. The method of claim 16, wherein the first indicator includes an identifier indicative of the predetermined category of the object.

18. The method of claim 15, further comprising:
in response to detecting a condition requiring driver intervention, outputting for display via the display system, a third indicator indicative of a request for driver intervention.

19. The method of claim 15, further comprising:
operating a vehicle environmental control system to vary ambient air conditions within a vehicle compartment based on content of the user-selected media.

20. The method of claim 15, further comprising:
operating a haptic actuator disposed within a vehicle seat based on content of the user-selected media.
